(19) United States
(12) Patent Application Publication
(10) Pub. No.: US 2021/0218887 A1
(43) Pub. Date: Jul. 15, 2021

(54) IMAGING APPARATUS

(71) Applicant: CANON KABUSHIKI KAISHA, Tokyo (JP)

(72) Inventor: Koichi Gunji, Kanagawa (JP)

(21) Appl. No.: 17/220,080

(22) Filed: Apr. 1, 2021

Related U.S. Application Data
(63) Continuation of application No. PCT/JP2019/036388, filed on Sep. 17, 2019.

(30) Foreign Application Priority Data
Oct. 4, 2018 (JP) 2018-188954
Mar. 22, 2019 (JP) 2019-054487

(51) Int. Cl. H04N 5/232; H04N 5/235

(52) U.S. Cl. CPC H04N 5/23232; H04N 5/232935; H04N 5/232939; H04N 5/2351

(57) ABSTRACT

An imaging apparatus according to the present invention includes at least one memory and at least one processor which function as: a generating unit configured to generate output image data on a basis of captured image data; an obtaining unit configured to obtain a characteristic value from the output image data; and an output unit configured to output the output image data and characteristic information based on the characteristic value, wherein in a case where an image area of the output image data includes a first area which is an image area of the captured image data and a second area which is an image area of predetermined image data, the obtaining unit obtains a characteristic value for the first area.

### CROSS-REFERENCE TO RELATED APPLICATIONS

This application is a Continuation of International Patent Application No. PCT/JP2019/036388, filed Sep. 17, 2019, which claims the benefit of Japanese Patent Application No. 2018-188954, filed Oct. 4, 2018, and Japanese Patent Application No. 2019-054487, filed Mar. 22, 2019, which are hereby incorporated by reference herein in their entirety.

### BACKGROUND OF THE INVENTION

### Field of the Invention

The present invention relates to an imaging apparatus.

### Background Art

An imaging apparatus such, as a digital camera and a digital video camera, can implement imaging (take and record images) while displaying images, which are obtained by imaging (captured images), on an EVF (an electronic view finder). For example, a display panel provided at an imaging apparatus or a display apparatus (an external apparatus) connected to the imaging apparatus is used as such an EVF, and a photographer checks various characteristic values about captured images while looking at the captured images displayed on the EVF.

The characteristic values that the photographer wants to check includes a luminance value (luminance level) of the captured image. In recent years, photography and display in HDR (High Dynamic Range), i.e., a relatively wide dynamic range (luminance range), have come into full swing, and standardization and commercialization related to HDR are in progress. For example, a standard such as HDR10+ defines additional information such as MaxCLL (Maximum Content Light Level), which indicates a maximum scene luminance value per scene and MaxFALL (Maximum Frame Average Light Level), which indicates a maximum frame average luminance value per scene. In the additional information, the information (MaxCLL and MaxCLL values) may vary dynamically between scenes. As for MaxCLL and MaxFALL, one frame can be treated as a single scene. More specifically, as for MaxCLL, a frame maximum luminance value can be indicated per frame, and as for MaxFALL, a frame average luminance value can be indicated per frame.

The additional information can be transmitted from an apparatus to another apparatus, e.g., from an imaging apparatus to a display apparatus, by communication conforming to, for example, the HDMI standard. The display apparatus can easily adjust the display luminance (the luminance on the display surface) by using the additional information as a luminance evaluation value for display. However, a predetermined image may be added to an edge of a captured image, and additional information not intended by the photographer may be generated. Specifically, additional information not intended by the photographer may be generated from an image having black bars image (bar-shaped black image) added to the top and bottom or left and right sides of the captured image. The state of an image with black bar images added to the top and bottom thereof is called a “letter box”, and the state of an image with black bar images added to the left and right sides thereof is called a “pillar box”.

PTL 1 discloses a display apparatus which obtains a characteristic value from an image by excluding a predetermined image area from an area for obtaining a characteristic value and controls emission luminance of a backlight source on the basis of the obtained characteristic value.

However, in the technology disclosed in PTL 1, a display apparatus having a function of obtaining a characteristic value from an image is necessary, and when the additional information (MaxCLL or MaxFALL) input to the display apparatus is used, the display luminance unintended by the photographer may be implemented.

The present invention provides technology which allows display luminance as intended by a photographer to be more surely implemented.

### CITATION LIST

### Patent Literature

PTL 1 Japanese Patent Laid-Open No. 2007-140483

### SUMMARY OF THE INVENTION

The present invention in its first aspect provides an imaging apparatus including at least one memory and at least one processor which function as: a generating unit configured to generate output image data on a basis of captured image data; an obtaining unit configured to obtain a characteristic value from the output image data; and an output unit configured to output the output image data and characteristic information based on the characteristic value, wherein in a case where an image area of the output image data includes a first area which is an image area of the captured image data and a second area which is an image area of predetermined image data, the obtaining unit obtains a characteristic value for the first area.

The present invention in its second aspect provides a control method of an imaging apparatus, including: generating output image data on a basis of captured image data; obtaining a characteristic value from the output image data; and outputting the output image data and characteristic information based on the characteristic value, wherein in a case where an image area of the output image data includes a first area which is an image area of the captured image data and a second area which is an image area of predetermined image data, a characteristic value for the first area is obtained.

The present invention in its third aspect provides a non-transitory computer readable medium that stores a program, wherein the program causes a computer to execute a control method of an imaging apparatus, the control method including: generating output image data on a basis of captured image data; obtaining a characteristic value from the output image data; and outputting the output image data and characteristic information based on the characteristic value, wherein in a case where an image area of the output image data includes a first area which is an image area of the captured image data and a second area which is an image area of predetermined image data, a characteristic value for the first area is obtained.

Further features of the present invention will become apparent from the following description of exemplary embodiments with reference to the attached drawings.

### BRIEF DESCRIPTION OF THE DRAWINGS

FIGS. 1A to 1D are block diagrams of exemplary configurations of imaging apparatuses according to first to fourth embodiments of the invention;

FIGS. 2A to 2C are flowcharts illustrating an exemplary flow of processing carried out by the imaging apparatus according to the first to fourth embodiments; and

FIGS. 3A to 3G are diagrams illustrating exemplary image data and other data according to the first to fourth embodiments.

### DESCRIPTION OF THE EMBODIMENTS

### First Embodiment

Hereinafter, a first embodiment of the present invention will be described. In the following description of the embodiment, the image processing apparatus is an imaging apparatus by way of illustration, while the image processing apparatus may be a personal computer (PC).

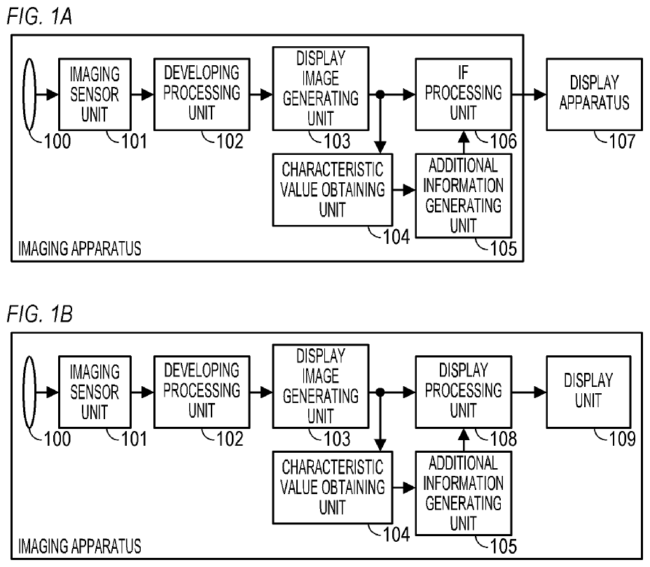

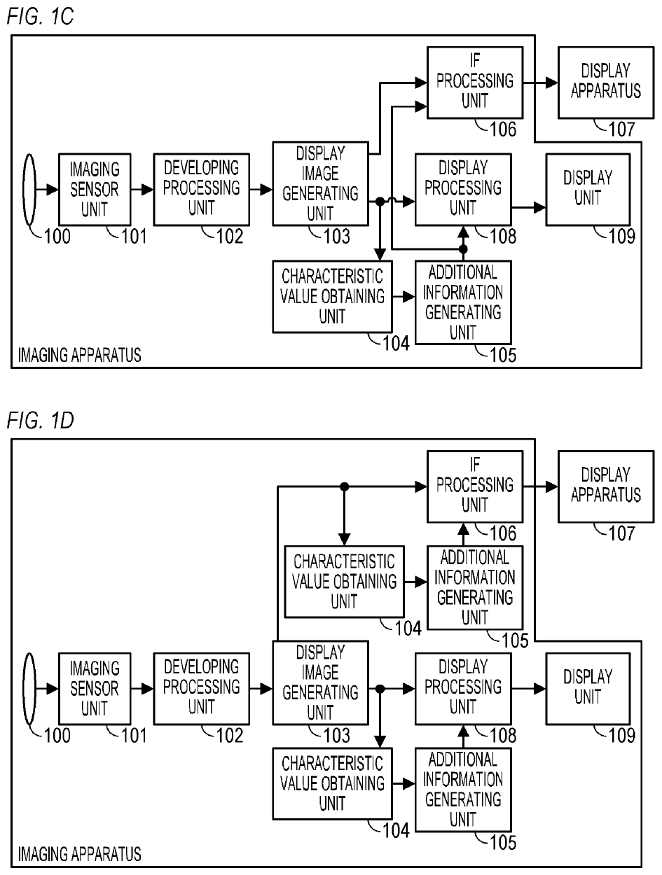

FIG. 1A is a block diagram of an exemplary configuration of an imaging apparatus according to the embodiment.

A lens group 100 includes at least one lens that guides light from an object to an imaging sensor unit 101. The lens group 100 is configured to control the quantity of light incident on the imaging sensor unit 101 from the lens group 100 and the state of focusing.

The imaging sensor unit 101 converts light incident from the lens group 100 into image data and outputs (transmits) the image data to a developing processing unit 102. Specifically, the imaging sensor unit 101 includes an image-sensing element such as a CCD and a CMOS and an A/D converter which converts an analog signal to a digital signal. The imaging-sensing element converts light incident from the lens group 100 which has formed an image at the image-sensing element into an analog signal (photoelectric conversion). The A/D converter converts the analog signal obtained by the image-sensing element into a digital signal (the image data).

Each of the pixels of the imaging-sensing element includes an R sub-pixel having a red color filter, a G sub-pixel having a green color filter, and a B sub-pixel having a blue color filter. In the pixels of the image-sensing element, the R sub-pixels, the G sub-pixels, and the B sub-pixels are provided in a predetermined arrangement. Specifically, in each of the pixels of the image-sensing element, one R sub-pixel, one B sub-pixel, and two G sub-pixels are arranged in a mosaic pattern. Such an arrangement is called a “Bayer array”, and image data output from the imaging sensor unit 101 (the A/D converter) is also image data in a Bayer array (Bayer image data).

The developing processing unit 102 performs developing processing on Bayer image data output from the imaging sensor unit 101 and outputs the image data resulting from the developing processing to a display image generating unit 103. The developing processing includes offset adjustment for adding offset values to gradation values (for example R, Q and B values), gain adjustment for multiplying a gradation value by a gain value, gamma transformation for transforming a gradation characteristic. The transformation characteristic of the gamma transformation (such as a gamma value and a gamma curve) are determined in consideration of the characteristics of the lens group 100 and the imaging sensor unit 101. When the transformation characteristics of the gamma transformation are changed, broadcasting image data can be generated or theatrical image data (such as image data which reproduces the texture or gradation of a motion picture film) can be generated. The developing processing includes processing for converting the Bayer image data (RGB image data in which each pixel includes one R sub-pixel, one B sub-pixel, and two G sub-pixels) into YCbCr image data. In the YCbCr image data, each pixel value includes a luminance value (Y value) and color difference values (a Cb value and a Cr value). The developing processing may include correction processing for correcting image distortion caused by the distortion of the lens group 100 (the lenses), vibration insulation processing for reducing the vibration of the image (the object taken in the image) caused the vibration of the imaging apparatus, and noise reduction processing for reducing the noise of the image.

The image data output from the developing processing unit 102 need not be YCbCr image data. For example, the developing processing may include debayering processing, and the developing processing unit 102 may perform debayering processing to convert the Bayer image data into RGB image data in which each pixel includes one R sub-pixel, one G sub-pixel, and one B sub-pixel and output the resulting data. The RGB image data, each pixel of which includes one R sub-pixel, one G sub-pixel, and one B sub-pixel, may be obtained (generated) by converting YCbCr image data. The RGB values (R, G, and B values) can be calculated from the YCbCr values (Y. Cb, and Cr values) or the YCbCr values can be calculated from the RGB values.

The image data output from the imaging sensor unit 101 or the developing processing unit 102 represents the object and is image data to be processed (target image data) in the imaging apparatus. The target image data is not limited to the image data obtained by imaging. For example, the target image data may be CG (computer graphics) image data.

The display image generating unit 103 generates display image data (output image data) on the basis the YCbCr image data output from the developing processing unit 102 and outputs the display image data to a characteristic value obtaining unit 104 and an IF processing unit 106. The display image data is image data to be displayed on the display surface. Specifically, the display image generating unit 103 converts the resolution (image size) of the YCbCr image data into the resolution of the display surface or adjusts the data size (bit width) of the gradation values (for example, the Y value, the Cb value, and the Cr value) of the YCbCr image data. The display image generating unit 103 also synthesizes the image data representing a predetermined graphic image into YCbCr image data so that a predetermined graphic image can be superimposed on the image represented by the YCbCr image data. The predetermined graphic image may be an image representing shooting assist information in a figure or text form. Further, when the aspect ratio of the YCbCr image data is different from the aspect ratio of the display surface, the display image generating unit 103 adds predetermined image data to the YCbCr image data so that the aspect ratio of the display image data coincides with the aspect ratio of the display surface. The display image data is generated by these kinds of processing.

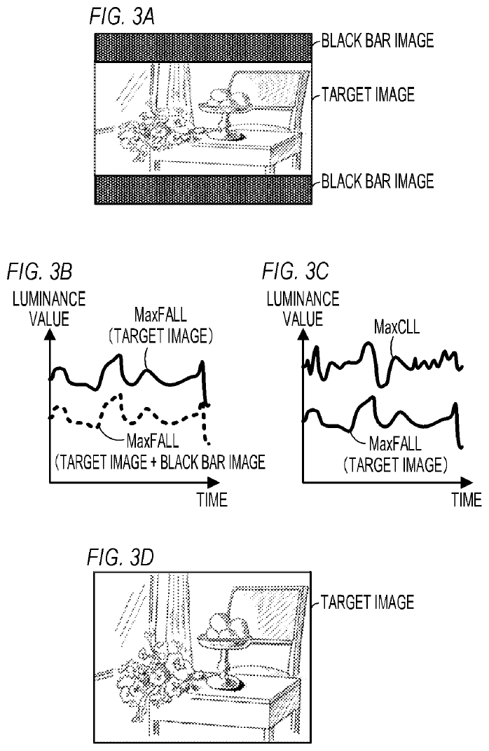

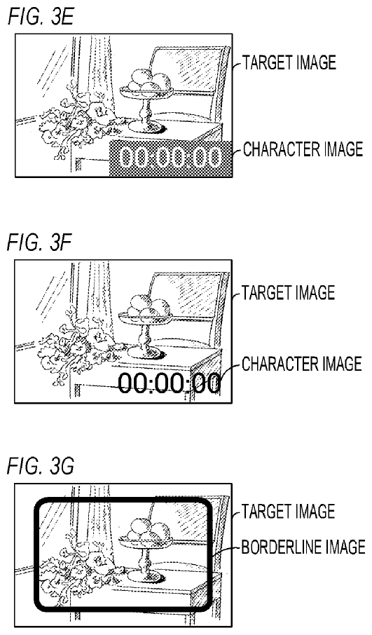

FIG. 3A shows exemplary display image data provided with predetermined additional image data. In FIG. 3A, an additional image (an image represented by the predetermined image data) is a black bar image (a bar-shaped black image), and the black bar images are added above and below the target image (the image represented by the YCbCr image data). The state shown in FIG. 3A is for example referred to as “letter boxed”. Black images may be added at the left and right sides of the target image, and the state is for example called a “pillar box”. The additional image may be other than such a black bar image or may be other than an image added to adjust the aspect ratio of the display image data. The shape or color of the additional image is not particularly limited. The additional images may include a drawn picture.

The characteristic value obtaining unit 104 obtains a characteristic value from the display image data generated by the display image generating unit 103 and outputs the characteristic value to an additional information generating unit 105. While the characteristic value is not particularly limited, according to the embodiment, MaxCLL (Maximum Content Light Level) which indicates a maximum scene luminance value per scene and MaxFALL (Maximum Frame Average Light Level) which indicates a maximum frame average luminance value per scene are obtained as characteristic values. Therefore, the characteristic values (MaxCLL and MaxCLL) may change dynamically between scenes. As for MaxCLL and MaxFALL, one frame can also be treated as one scene. More specifically, MaxCLL can represent a frame maximum luminance value per frame, and MaxFALL can represent a frame average luminance value per frame. According to the embodiment. MaxCLL which indicates a frame maximum luminance value per frame and MaxFALL which indicates a frame average luminance value per frame are obtained as characteristic values.

In the conventional case, as the average luminance value (MaxFALL) of the display image data shown in FIG. 3A, the average luminance value of the entire image area (the entire image area including the image area of a target image and the image area of a black bar image) of the display image data is obtained. Therefore, the obtained average luminance value is different from the average luminance value of the target image and is also different from the value as intended by the photographer (the user of the image processing apparatus). The dashed line in FIG. 3B shows MaxFALL obtained in the conventional case from the display image data in FIG. 3A.

Therefore, according to the embodiment, the characteristic value obtaining unit 104 obtains the average luminance value of the image area of the target image as the average luminance value (MaxFALL) of the display image data without considering the image area of the black bar image. In this way, MaxFALL which indicates an average luminance value as intended by the photographer (the user of the image processing apparatus) can be obtained. The solid line in FIG. 3B shows MaxFALL obtained from the display image data in FIG. 3A according to the embodiment. With the additional image, MaxFALL (the dashed line) in the conventional case indicates lower average luminance value than MaxFALL (the solid line) according to the embodiment. Therefore, in the conventional case, a display luminance lower than that intended by the photographer results on the basis of MaxFALL (the dashed line). According to the embodiment, the photographer can obtain MaxFALL indicating the average luminance value as intended by the photographer, so that the display luminance as intended by the photographer can be achieved on the basis of MaxFALL (the solid line). Since the display image data is generated by the imaging apparatus, the imaging apparatus can individually determine the image area of the black bar image and the image area of the target image.

According to the embodiment, since the color of the additional image is black, the additional image does not affect the maximum luminance value (MaxCLL) of the display image data. Therefore, the characteristic value obtaining unit 104 may obtain, as the maximum luminance value (MaxCLL) of the display image data, the maximum luminance value of the entire image area of the display image data or may obtain the maximum luminance value of the image area of the target image. FIG. 3C shows MaxFALL and MaxCLL obtained from the display image data in FIG. 3A according to the embodiment. When the additional image contains colors other than black (such as white), the additional image may affect the maximum luminance value (MaxCLL) of the display image data. In this case, the characteristic value obtaining unit 104 may obtain the maximum luminance value of the image area of the target image as the maximum luminance value (MaxCLL) of the display image data without considering the image area of the additional image. In this way, MaxCLL which indicates the maximum luminance value as intended by the photographer can be more surely obtained, and the display luminance as intended by the photographer can be more surely achieved.

The additional information generating unit 105 generates additional information to be added to the display image data on the basis of the characteristic value (MaxCLL or MaxFALL) obtained by the characteristic value obtaining unit 104. The additional information generating unit 105 outputs the additional information to the IF processing unit 106. For example, the additional information is information based on the HDMI standard and includes characteristic information for example indicating MaxCLL or MaxFALL. The additional information includes area information indicating the image area for which the characteristic value (MaxCLL or MaxFALL) is obtained. According to the embodiment, the area information indicates whether MaxFALL has been obtained from the entire image area of the display image data or from the image area of the target image alone. The area information need not be included in the additional information.

The IF processing unit 106 adds the additional information generated by the additional information generating unit 105 to the display image data generated by the display image generating unit 103 and outputs the resulting display image data to a display apparatus 107 (an external apparatus) connected to the imaging apparatus. Specifically, a display unit 109 is connected to the imaging apparatus by a connection method for example according to the HDMI standard. The IF processing unit 106 generates a signal in a format according to the HDMI standard as a signal including the display image data and the additional information and outputs the generated signal to the display apparatus 107. The display image data and the additional information may be separately output. The display image data and the additional information may be recorded in a storage apparatus instead of being output to the display apparatus 107.

The display apparatus 107 may be used as an electronic viewfinder (EVF) for the imaging apparatus. The display apparatus 107 extracts the display image data and the additional information from the signal received from the imaging apparatus and displays an image based on the display image data on the display surface with a display luminance based on the additional information (such as MaxCLL and MaxFALL). The display luminance is the luminance on the display surface. When the display apparatus 107 is a liquid crystal display, the display luminance can be adjusted by adjusting the luminance of light emitted by the backlight unit and the transmittance of the liquid crystal panel. Specifically, the display luminance can be adjusted by adjusting the voltage and current supplied to the backlight unit and the voltage and current supplied to the LCD panel. When the display apparatus 107 is an organic EL display or a plasma display apparatus, the display luminance can be adjusted by adjusting the luminance of the light emitted from the display panel (the organic EL panel or plasma panel). Specifically, the display luminance can be adjusted by adjusting the voltage and current supplied to the display panel.

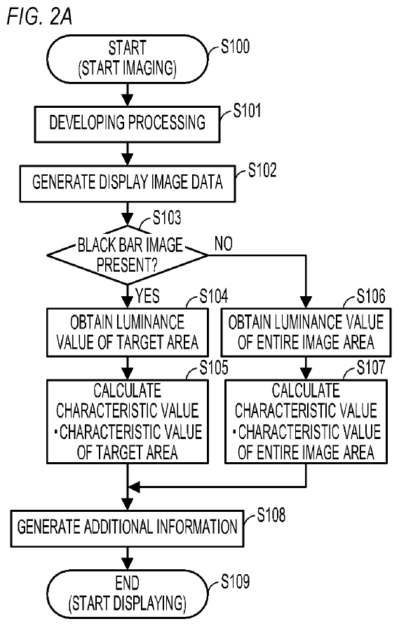

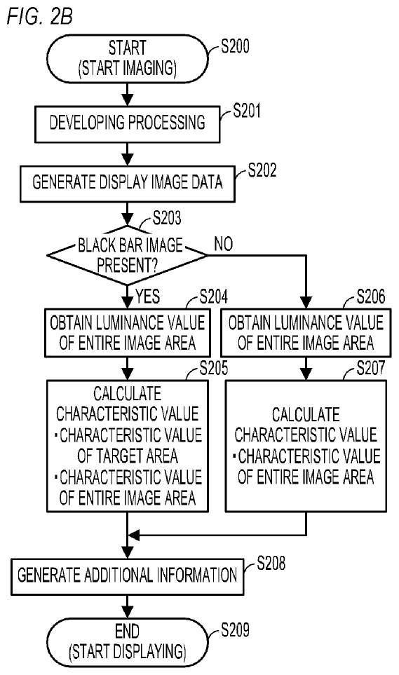

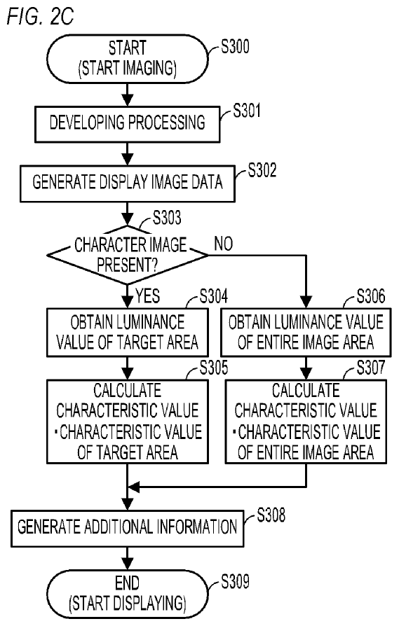

FIG. 2A is a flowchart for illustrating an exemplary flow of processing carried out by the imaging apparatus according to the embodiment.

In step S100, the imaging sensor unit 101 starts imaging. In step S101, the developing processing unit 102 performs developing processing. In step S102, the display image generating unit 103 generates display image data from the image data after the developing processing. The image area of the display image data includes at least the image area of a target image. When the display image data is for example in a letterboxed or pillar-boxed state, the image area of the display image data further includes the image area of the black bar images.

In step S103, the characteristic value obtaining unit 104 determines whether the image area of the display image data generated in step S102 includes the image area of black bar images. If there is the image area of black bar images (for example when the display image data is letter-boxed or pillar-boxed), the process proceeds to step S104, otherwise the process proceeds to step S106.

In step S104, the characteristic value obtaining unit 104 obtains (extracts) the luminance value of each pixel in the image area (target area) of the target image from the display image data generated in step S102 without obtaining the luminance value of the image area of the black bar images. In step S105, the characteristic value obtaining unit 104 calculates a characteristic value (MaxCLL or MaxFALL) using the luminance values obtained in step S104. For example, MaxCLL indicates the maximum frame luminance value (the maximum luminance value of the pixels) per frame, and MaxFALL indicates the frame average luminance value (the average luminance value of the pixels) per frame.

In step S106, the characteristic value obtaining unit 104 obtains (extracts) the luminance value of each pixel in the entire image area (the entire image area of the display image data) from the display image data generated in step S102. In step S107, the characteristic value obtaining unit 104 calculates a characteristic value (MaxCLL or MaxFALL) using the luminance values obtained in step S106.

In step S108, the additional information generating unit 105 generates additional information on the basis of the characteristic value (MaxCLL or MaxFALL) calculated in step S105 or S107.

In step S109, the IF processing unit 106 adds the additional information generated in step S108 to the display image data generated in step S102 and outputs the resulting display image data to the display apparatus 107. The display apparatus 107 displays an image based on the display image data output from the IF processing unit 106 on the display surface (the start of display) with the display luminance based on the additional information (for example MaxCLL or MaxFALL) output from the IF processing unit 106.

As described above, according to the embodiment, in the imaging apparatus (the image processing apparatus) discrete from the display apparatus, a characteristic value as intended by the photographer (the user of the image processing apparatus) is obtained, and characteristic information as intended by the photographer is generated. In this way, the display luminance as intended by the photographer can surely be provided. For example, the display apparatus can provide a display luminance as intended by the photographer on the basis of characteristic information generated by the imaging apparatus, even though the apparatus is not capable of obtaining an optimal characteristic value.

### Second Embodiment

Hereinafter, a second embodiment of the present invention will be described. In the following description, points different from those of the first embodiment (such as configuration and processing) will be described in detail, while points identical to those of the first embodiment will not be described.

FIG. 1B is a block diagram of an exemplary configuration of an imaging apparatus according to the embodiment. The imaging apparatus according to the embodiment is not connected to a display apparatus (an external apparatus) and has a display processing unit 108 instead of the IF processing unit 106 according to the first embodiment (FIG. 1A). The imaging apparatus according to the embodiment also includes a display unit 109.

The display processing unit 108 generates control information for controlling for example display luminance on the basis of additional information (for example MaxCLL or MaxFALL) generated by the additional information generating unit 105. The control information can also be considered as “information based on the characteristic value obtained by the characteristic value obtaining unit 104”. The display processing unit 108 outputs (transmits), to the display unit 109, display image data generated by the display image generating unit 103 and the control information generated on the basis of the additional information. For example, the display unit 109 is connected to the display processing unit 108 by a connection method for example according to the MIPI standard, and the display processing unit 108 generates and outputs a signal in a format according to the MIPI standard as a signal representing the control information.

The display unit 109 may be used as an electronic viewfinder (EVF). The display unit 109 displays an image based on the display image data output from the display processing unit 108 on the display surface with a display luminance based on the control information (for example MaxCLL or MaxFALL) output from the display processing unit 108. When the display unit 109 is a combination of a liquid crystal panel and a backlight unit, the display luminance can be adjusted by adjusting the luminance of the backlight unit and the transmittance of the liquid crystal panel. When the display unit 109 is a display panel such as an organic EL panel and a plasma panel, the display luminance can be adjusted by adjusting the luminance of light emitted by the display panel.

The flow of processing carried out by the imaging apparatus according to the embodiment is the same as that of the first embodiment (FIG. 2A). However, in step S109, the display processing unit 108 generates the control information based on the additional information generated in step S108 and outputs the display image data (step S102) and the control information to the display unit 109. The display unit 109 displays an image based on the display image data output from the display processing unit 108 on the display surface with a display luminance based on the control information (for example MaxCLL or MaxFALL) output from the display processing unit 108 (the start of display).

As described above, according to the embodiment, the display luminance as intended by the photographer (the user of the image processing apparatus) can be more reliably achieved by the imaging apparatus (the image processing apparatus) alone.

### Third Embodiment

Hereinafter, a third embodiment of the present invention will be described. In the following description, points different from those of the first and second embodiments (for example configurations and processing) will be described in detail, while points identical to those of the first and second embodiments will not be described.

FIG. 1C is a block diagram of an exemplary configuration of an imaging apparatus according to the embodiment. The imaging apparatus according to the embodiment has a configuration resulting from combining the configuration of the first embodiment (FIG. 1A) and the configuration of the second embodiment (FIG. 1B). Specifically, the display image generating unit 103 outputs display image data to the characteristic value obtaining unit 104, the IF processing unit 106, and the display processing unit 108. The additional information generating unit 105 outputs additional information to the IF processing unit 106 and the display processing unit 108.

FIG. 2B is a flowchart for illustrating an exemplary flow of processing carried out by the imaging apparatus according to the embodiment.

In step S200, the imaging sensor unit 101 starts imaging. In step S202, the developing processing unit 102 performs developing processing. Common image data may or may not be obtained between the display apparatus 107 and the display unit 109 as image data after the developing processing by one kind of developing processing. The developing processing for the display apparatus 107 and the developing processing for the display unit 109 may be performed separately, and the image data for the display apparatus 107 and the image data for the display unit 109 may be separately obtained as the image data after the developing processing.

In step S202, the display image generating unit 103 generates display image data from the image data after the developing process. According to the embodiment, the display image generating unit 103 separately generates the display image data for the display apparatus 107 and the display image data for the display unit 109. Therefore, only one of the two display image data pieces may have a black bar image, or both of the two display image data may have a black bar image. According to the embodiment, it is assumed that the display image data for the display apparatus 107 includes the image data as shown in FIG. 3A (letterboxed image data with black bar images). It is also assumed that the display image data for the display unit 109 is image data as shown in FIG. 3D (image data with no black bar images or image data on the target image alone). In some cases, the display image data for the display apparatus 107 does not have black bar images, and there are black bar images in the display image data for the display unit 109. Common display image data may be generated for the display apparatus 107 and the display unit 109.

In step S203, the characteristic value obtaining unit 104 determines whether the image area of the display image data generated in step S202 includes the image area of black bar images. The determination in step S203 is carried out separately between the display image data for the display apparatus 107 and the display image data for the display unit 109. The display image data with the image area of the black bar images is processed in steps S204 and S205, and the display image data without the image area of the black bar images is processed in steps S206 and S207. According to the embodiment, since the display image data for the display apparatus 107 is the image data in FIG. 3A, processing in steps S204 and S205 is carried out for the display image data for the display apparatus 107. Since the display image data for the display unit 109 is the image data in FIG. 3D, processing in steps S206 and S207 is carried out to the display image data for the display unit 109.

In step S204, the characteristic value obtaining unit 104 obtains (extracts) the luminance values of the pixels in the entire image area (the entire image area including the image area of the target image and the image area of the black bar images) from the display image data generated in step S202. In step S205, the characteristic value obtaining unit 104 calculates a characteristic value (MaxCLL or MaxFALL) using the luminance values obtained in step S206. Specifically, the characteristic value obtaining unit 104 obtains the characteristic value of the image area of the target image using the luminance values of pixels in the image area of the target image similarly to the first and second embodiments. The characteristic value obtaining unit 104 obtains the characteristic value of the entire image area using the luminance values of the pixels in the entire image area.

In step S206, the characteristic value obtaining unit 104 obtains (extracts) the luminance values of the pixels in the entire image area (the entire image area of the display image data) from the display image data generated in step S202. In step S207, the characteristic value obtaining unit 104 calculates a characteristic value (MaxCLL or MaxFALL) using the luminance values obtained in step S206. Specifically, the characteristic value obtaining unit 104 obtains the characteristic value of the entire image area using the luminance values of the pixels in the entire image area similarly to the first and second embodiments.

In step S208, the additional information generating unit 105 generates additional information based on the characteristic value (MaxCLL or MaxFALL) calculated in step S105 or S107. As described above, according to the embodiment, processing in steps S204 and S205 is carried out for the display image data for the display apparatus 107. Therefore, in the additional information for the display apparatus 107, area information representing the image area of the target image is associated with the characteristic value of the image area of the target image, and area information representing the entire image area is associated with the characteristic value of the entire image area. The display image data for the display unit 109 is subjected to processing in step S206 and the S207. Therefore, the additional information for the display unit 109 includes information indicating that the characteristic value does not include that of black bar images.

In step S209, the IF processing unit 106 and the display apparatus 107 display an image based on the display image data generated in step S202 on the display surface of the display apparatus 107 with a display luminance based on the additional information generated in step S208 similarly to the first embodiment. The display processing unit 108 and the display unit 109 display an image based on the display image data generated in step S202 on the display surface of the display unit 109 with a display luminance based on the additional information generated in step S208 similarly to the second embodiment.

According to the embodiment, as the characteristic value (MaxCLL or MaxFALL) for the display apparatus 107, the characteristic value of the image area of the target image and the characteristic value of the entire image area (the entire image area including the image area of the target image and the image area of the black bar images) are obtained. Therefore, when an image is displayed at the display apparatus 107, the two characteristic values can be selectively used. Using the characteristic value of the image area of the target image, the display luminance as intended by the photographer can be achieved similarly to the first embodiment. The use of the characteristic value (MaxFALL) of the entire image area lowers the display luminance for the part of the black bar images, so that the power consumption of the display apparatus 107 can be reduced.

As in the foregoing, according to the embodiment, since both the processing according to the first embodiment and the processing according to the second embodiment are performed, both the effects of the first and second embodiments can be provided. Since the same apparatus generates the additional information for the display apparatus 107 and the additional information for the display unit 109, the image displayed at the display apparatus 107 and the image displayed at the display unit 109 can be made to look similar to each other. When an image is displayed, the characteristic value of the target image and the characteristic value of the image including the target image and the black bar images can be selectively used, and therefore the display luminance as intended by the photographer (the user of the image processing apparatus) and the display luminance for reduced power consumption can be preferably selectively achieved.

As shown in FIG. 1D, for the pairs the characteristic value obtaining units 104 and the additional information generating units 105, the display apparatus 107 and the display unit 109 may be provided separately.

### Fourth Embodiment

Hereinafter, a fourth embodiment of the present invention will be described. Points different from those of the first to third embodiments (such as configurations and processing) will be described in detail, and points identical to those of the first to third will not be described.

FIG. 1A, which is a diagram of the first embodiment, also shows an exemplary configuration of an imaging apparatus according to the embodiment.

FIGS. 3E, 3F, and 3G each show exemplary display image data with predetermined additional image data generated by the display image generating unit 103. In FIG. 3E, an additional image (an image represented by predetermined image data) is a character image (a timecode image representing shooting time or playback time), and the character image is added to the lower right part of the target image (an image represented by YCbCr image data). The character image may be enclosed in a frame as shown in FIG. 3E or may include characters alone as shown in FIG. 3F. The additional image in FIG. 3G is a borderline image which indicates for example an actual recording area in the display image data. The shape and color of the additional image (a character image or a borderline image) and its superimposed position in the display image data are not particularly limited. The additional image may be an image in which characters and a picture are included.

According to the embodiment, the characteristic value obtaining unit 104 obtains the average luminance value and the maximum luminance value of the image area of the target image as the average luminance value (MaxFALL) and the maximum luminance value (MaxCLL) of the display image data without considering the image area of the character image. As a result, MaxFALL which indicates the average luminance value or the maximum luminance value (MaxCLL) as intended by the photographer (the user of the image processing apparatus) can be obtained, so that the display luminance as intended by the photographer can be achieved. The display luminance unintended by the photographer may be obtained, when the average luminance value or maximum luminance value of the entire image area of the display image data including the image area of the character image is obtained, and the color of the character image is black (when the luminance value is low) or white (when the luminance value is high). Since the display image data is generated by the imaging apparatus, the image area of the character image or the image area of the target image can be individually determined by the imaging apparatus. The determining method may be based on the area information as well as a pixel value and a gradation value in the image area of the character image, and therefore the image area of the additional image can be set as an image area that includes the unique pixel value and gradation value specified by the photographer. When the pixel value or gradation value specified by the photographer for the image area of the additional image is also included in the target image, the pixel value or gradation value specified by the photographer must be changed to a pixel value or a gradation value which is not included in the target image (for example to a value of +1 from the specified value), and the unique pixel value or gradation value must be used.

FIG. 2C is a flowchart for illustrating an exemplary flow of processing carried out by the imaging apparatus according to the embodiment.

In step S300, the imaging sensor unit 101 starts imaging. In step S301, the developing processing unit 102 performs developing processing. In step S302, the display image generating unit 103 generates display image data from the image data after the developing process. The image area of the display image data includes at least the image area of a target image. When a character image is superimposed in generating the display image data, the image area of the display image data further includes the image area of the character image. In this example according to the embodiment, a character image is superposed, while the image may be a borderline image as shown in FIG. 3G or a figure or a picture, or other characters that show the shooting information or the playback information.

In step S303, the characteristic value obtaining unit 104 determines whether the image area of the display image data generated in step S302 includes the image area of a character image. When there is the image area of a character image, the process proceeds to step S304, otherwise the process proceeds to step S306.

In step S304, the characteristic value obtaining unit 104 obtains (extracts) the luminance value of the pixels in the image area (target area) of the target image from the display image data generated in step S302 without obtaining the luminance values in the image area of the character image. In step S305, the characteristic value obtaining unit 104 calculates a characteristic value (MaxCLL or MaxFALL) using the luminance values obtained in step S304. For example, MaxCLL indicates the frame maximum luminance value (the maximum luminance value of the pixels) per frame, and MaxFALL indicates the average frame luminance value (the average value of the luminance values of the pixels) per frame.

In step S306, the characteristic value obtaining unit 104 obtains (extracts) the luminance values of the pixels in the entire image area (the entire image area of the display image data) from the display image data generated in step S302. In step S307, the characteristic value obtaining unit 104 calculates a characteristic value (MaxCLL or MaxFALL) using the luminance values obtained in step S306.

In step S308, the additional information generating unit 105 generates additional information on the basis of the characteristic value (MaxCLL or MaxFALL) calculated in step S305 or S307.

In step S309, the IF processing unit 106 adds the additional information generated in step S308 to the display image data generated in step S302 and outputs the resulting data to the display apparatus 107. The display apparatus 107 displays an image based on the display image data output from the IF processing unit 106 on the display surface (the start of display) with a display luminance based on the additional information (for example MaxCLL or MaxFALL) output from the IF processing unit 106.

As in the foregoing, according to the embodiment, in the imaging apparatus (the image processing apparatus) discrete from the display apparatus, a characteristic value as intended by the photographer (the user of the image processing apparatus) is obtained, and characteristic information as intended by the photographer is generated. In this way, the display luminance as intended by the photographer can more surely be achieved. For example, the display apparatus can provide a display luminance as intended by the photographer on the basis of characteristic information generated by the imaging apparatus, even though the apparatus is not capable of obtaining an optimal characteristic value.

The configuration of the imaging apparatus when there is the image area of a character image described in conjunction with the embodiment is only an example, and a display luminance as intended by the photographer can be achieved in the configurations according to the second and third embodiments.

The blocks according to the first to fourth embodiments (FIGS. 1A to 1D) may or may not be discrete hardware. The functions of at least two blocks may be implemented by common hardware. Each of the plurality of functions of one block may be implemented by discrete hardware. At least two functions of one block may be implemented by common hardware. The blocks may or may not be implemented by hardware. For example, the apparatus may include a processor and a memory for storing a control program. The functions of at least some of the blocks of the apparatus may then be implemented as the processor reads the control program from the memory and executes the program.

The first to fourth embodiments (including the modifications described above) are merely exemplary, and configurations obtained by modifying or changing, as appropriate, the configurations according to the first to fourth embodiments within the scope and spirit of the present invention are also encompassed by the present invention. Configurations obtained by combining the configurations according to the first to fourth embodiments as appropriate are also encompassed by the present invention.

According to the present disclosure, a display luminance as intended by the photographer for example can be more surely achieved.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An imaging apparatus comprising at least one memory and at least one processor which function as:
a generating unit configured to generate output image data on a basis of captured image data;
an obtaining unit configured to obtain a characteristic value from the output image data; and
an output unit configured to output the output image data and characteristic information based on the characteristic value, wherein
in a case where an image area of the output image data includes a first area which is an image area of the captured image data and a second area which is an image area of predetermined image data, the obtaining unit obtains a characteristic value for the first area.

2. The imaging apparatus according to claim 1, wherein the characteristic value is an average luminance value.

3. The imaging apparatus according to claim 1, wherein the characteristic value is a maximum luminance value.

4. The imaging apparatus according to claim 1, wherein the output unit outputs the output image data and the characteristic information to a display apparatus.

5. The imaging apparatus according to claim 1, wherein the predetermined image data is image data added to adjust an aspect ratio of the output image data.

6. The imaging apparatus according to claim 1, wherein the predetermined image data is image data added to indicate image-capture information or playback information relating to the output image data.

7. The imaging apparatus according to claim 1, wherein in a case where an image area of the output image data includes the first area which is the image area of the captured image data and the second area which is the image area of the predetermined image area, the obtaining unit further obtains a characteristic value for an entire image area of the output image data.

8. The imaging apparatus according to claim 1, wherein the output unit further outputs area information indicating an image area for which the characteristic value is obtained.

9. A control method of an imaging apparatus, comprising:
generating output image data on a basis of captured image data;
obtaining a characteristic value from the output image data; and
outputting the output image data and characteristic information based on the characteristic value, wherein
in a case where an image area of the output image data includes a first area which is an image area of the captured image data and a second area which is an image area of predetermined image data, a characteristic value for the first area is obtained.

10. A non-transitory computer readable medium that stores a program, wherein the program causes a computer to execute a control method of an imaging apparatus, the control method comprising:
generating output image data on a basis of captured image data;
obtaining a characteristic value from the output image data; and
outputting the output image data and characteristic information based on the characteristic value, wherein
in a case where an image area of the output image data includes a first area which is an image area of the captured image data and a second area which is an image area of predetermined image data, a characteristic value for the first area is obtained.
